(19) United States
(12) Patent Application Publication
(10) Pub. No.: US 2007/0291493 A1
(43) Pub. Date: Dec. 20, 2007

(54) Webbing structure with a banded light-emitting effect and method for manufacturing the same

(76) Inventors: Chi-Tsung Peng, Taipei (TW); Chien-Tang Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/505,999

(22) Filed: Aug. 18, 2006

(30) Foreign Application Priority Data
Jun. 16, 2006 (TW) 95121807

(51) Int. Cl. F21V 3/00

(52) U.S. Cl. 362/311

(57) ABSTRACT

A webbing structure with a banded light-emitting effect includes two opaque band sets, a transparent band set, a plurality of longitudinal opaque wires, and a light-emitting module. Each opaque band set is composed of a plurality of latitudinal opaque wires. The transparent band set is arranged between the two opaque band sets, wherein the transparent band set is composed of latitudinal flexible transparent wires. The longitudinal opaque wires are respectively longitudinally alternately interweaved among the latitudinal opaque wires and the latitudinal flexible transparent wires. In addition, the light-emitting module is disposed beside an end side of the transparent band set. Thereby, when light source is projected from the light-emitting module into the transparent band set, the transparent band set becomes a banded shining area.

### BACKGROUND OF THE INVENTION

1. Field of The Invention

The present invention relates to a webbing structure with a banded light-emitting effect and a method for manufacturing the same, and particularly relates to flexible transparent wires respectively interweaved with opaque wires each other, for producing a webbing structure with a banded shining area.

2. Description of the Related Art

Webbing, a kind of ribbon, composed from a number of single filaments. Thus, the strength and durability of webbing is commonly used in everyday life. For example, pet collars and its draglines, shoelaces, and ribbon decorations on clothes.

Nevertheless, the composition of traditional webbing does not normally possess the attribute of vivid warning light. Furthermore, if the traditional webbing is composed of reflecting filaments, the webbing itself is still a passive luminant. Hence, the drawback of reflecting webbing is the need for external light source to summon up the reflecting warning light.

### SUMMARY OF THE INVENTION

The present invention provides a webbing structure with a banded light-emitting effect. The webbing structure is manufactured via flexible transparent wires respectively interweaving with opaque wires each other. Moreover, a light-emitting module provides a light source and transmits the light source into the flexible transparent wires for generating a banded shining area.

A first aspect of the invention is a webbing structure with a banded light-emitting effect, comprising: two opaque band sets, a transparent band set, a plurality of longitudinal opaque wires, and a light-emitting module. Each opaque band set is composed of a plurality of latitudinal opaque wires. The transparent band set is arranged between the two opaque band sets, wherein the transparent band set is composed of latitudinal flexible transparent wires. The longitudinal opaque wires are respectively longitudinally alternately interweaved among the latitudinal opaque wires and the latitudinal flexible transparent wires. In addition, the light-emitting module is disposed beside an end side of the transparent band set. Thereby, when light source is projected from the light-emitting module into the transparent band set, the transparent band set becomes a banded shining area.

A second aspect of the invention is a webbing structure with a banded light-emitting effect, comprising: a plurality of opaque band sets, a plurality of transparent band sets, a plurality of longitudinal opaque wires, and a light-emitting module. Each opaque band set is composed of a plurality of latitudinal opaque wires. Each transparent band set is arranged between each two corresponding opaque band sets, and each transparent band set is composed of latitudinal flexible transparent wires. The longitudinal opaque wires are respectively longitudinally alternately interweaved among the latitudinal opaque wires and the latitudinal flexible transparent wires. In addition, the light-emitting module is disposed beside end sides of the transparent band sets. Thereby, when light source is projected from the light-emitting module into the transparent band sets, each transparent band set becomes a banded shining area.

A third aspect of the invention is a method for manufacturing a webbing structure with a banded light-emitting effect, comprising: providing two opaque band sets, wherein each opaque band set is composed of a plurality of latitudinal opaque wires; arranging a transparent band set between the two opaque band sets, wherein the transparent band set is composed of latitudinal flexible transparent wires; respectively longitudinally alternately interweaving a plurality of longitudinal opaque wires among the latitudinal opaque wires and the latitudinal flexible transparent wires; disposing a light-emitting module beside an end side of the transparent band set; and then projecting light source from the light-emitting module into the transparent band set for the transparent band set to from a banded shining area.

A fourth aspect of the invention is a method for manufacturing a webbing structure with a banded light-emitting effect, comprising: providing a plurality of opaque band sets, wherein each opaque band set is composed of a plurality of latitudinal opaque wires; providing a plurality of transparent band sets, and arranging each transparent band set between each two corresponding opaque band sets, wherein each transparent band set is composed of latitudinal flexible transparent wires; respectively longitudinally alternately interweaving a plurality of longitudinal opaque wires among the latitudinal opaque wires and the latitudinal flexible transparent wires; disposing a light-emitting module beside end sides of the transparent band sets; and then projecting light source from the light-emitting module into the transparent band sets for each transparent band set to form a banded shining area.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a front, schematic view of a webbing structure with a banded light-emitting effect according to the first embodiment of the present invention;

FIG. 2 is a side, schematic view of a webbing structure with a banded light-emitting effect according to the first embodiment of the present invention;

FIG. 3 is a side, schematic view of a webbing structure with a banded light-emitting effect according to the second embodiment of the present invention;

FIG. 4 is a front, schematic view of a webbing structure with a banded light-emitting effect according to the third embodiment of the present invention;

FIG. 5 is a side, schematic view of a webbing structure with a banded light-emitting effect according to the third embodiment of the present invention;

FIG. 6 is a side, schematic view of a webbing structure with a banded light-emitting effect according to the fourth embodiment of the present invention;

FIG. 7 is a front, schematic view of a webbing structure with a banded light-emitting effect according to the fifth embodiment of the present invention;

FIG. 8 is a perspective, schematic view of a webbing structure with a banded light-emitting effect applied to clothing according to the first embodiment of the present invention;

FIG. 9 is a perspective, schematic view of a webbing structure with a banded light-emitting effect applied to a shoe according to the first embodiment of the present invention;

FIG. 10 is a flow chart of a method for manufacturing a webbing structure with a banded light-emitting effect according to the first embodiment of the present invention; and

FIG. 11 is a flow chart of a method for manufacturing a webbing structure with a banded light-emitting effect according to the third and the fourth embodiment of the present invention.

### DETAILED DESCRIPTION OF PREFERRED EMBODIMENTS

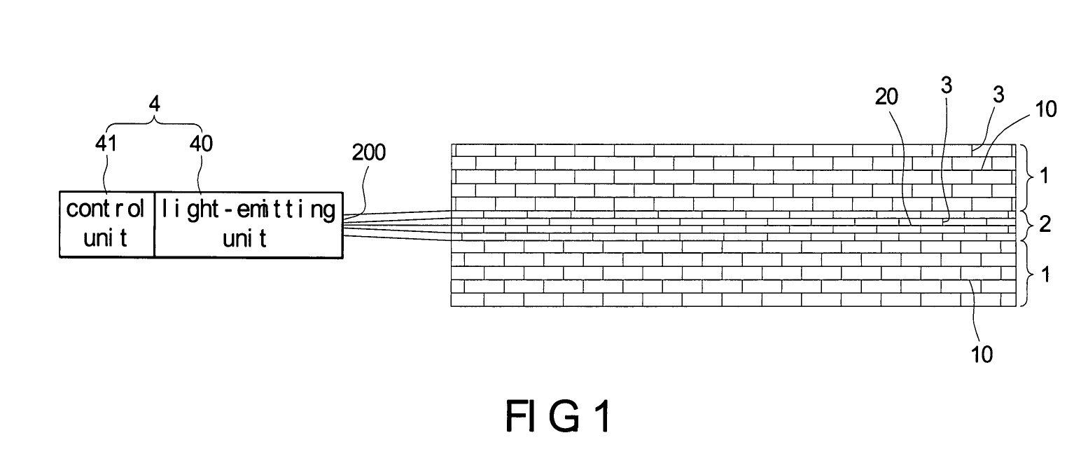

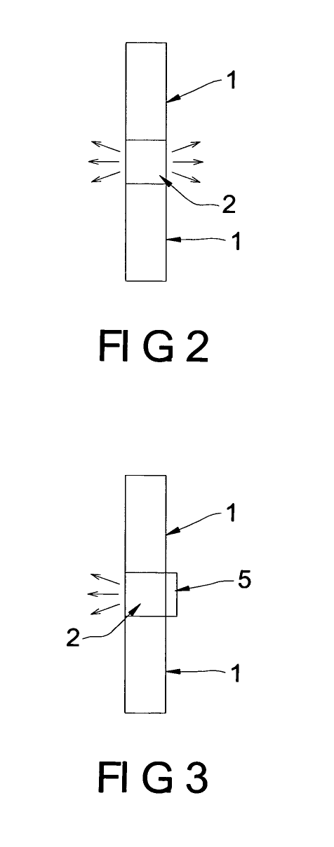

Referring to FIGS. 1 and 2, the first embodiment of the present invention provides a webbing structure with a banded light-emitting effect, comprising: two opaque band sets 1, a transparent band set 2, a plurality of longitudinal opaque wires 3, and a light-emitting module 4.

Each opaque band set 1 is composed of a plurality of latitudinal opaque wires 10. The opaque band set 1 is a straight opaque band set. Moreover, the transparent band set 2 is arranged between the two opaque band sets 1, and the transparent band set 2 is composed of latitudinal flexible transparent wires 20. In addition, the longitudinal opaque wires 3 are respectively longitudinally alternately interweaved among the latitudinal opaque wires 10 and the latitudinal flexible transparent wires 20.

Moreover, the latitudinal opaque wires 10 and the longitudinal opaque wires 3 can be chemical yarns or any opaque yarns. The latitudinal flexible transparent wires 20 can be optical fibers or any wire with a flexible and transparent function. In addition, the latitudinal flexible transparent wires 20 can be made of transparent thermoplastic material; alternatively, each latitudinal flexible transparent wire 20 can be selected from the group consisting of polycarbonate, polystyene, polymethyl methacrylate, MMA-styrene Copolymer, thermoplastic Polyurethane and ethylene vinyl acetate. However, above-mentioned materials of the latitudinal flexible transparent wires 20 do not use to limit the present invention. Hence, any material with an opaque function or a flexible and transparent function is protected in the present invention.

Furthermore, the light-emitting module 4 is disposed beside an end side of the transparent band set 2. The light-emitting module 4 is composed of a light-emitting unit 40 for generating light source and a control unit 41 for controlling the light-emitting unit 40. Hence, when the end sides of the latitudinal flexible transparent wires 20 are bound as the end side of the transparent band set 2 to form a light source inlet 200, light source of the light-emitting unit 40 is projected toward the light source inlet 200. Thereby, when the light source is projected from the light-emitting module 4 into the transparent band set 2, the transparent band set 2 becomes a double-faced banded shining area for lighting as the arrows shown in FIG. 2.

Referring to FIG. 3, the difference between the second embodiment and the first embodiment is that the webbing structure of the second embodiment further comprises a reflective layer 5 disposed on one side face of the transparent band set 2 for only other side face of the transparent band set 2 generating a single-faced banded shining area that projects light as the arrows in FIG. 3.

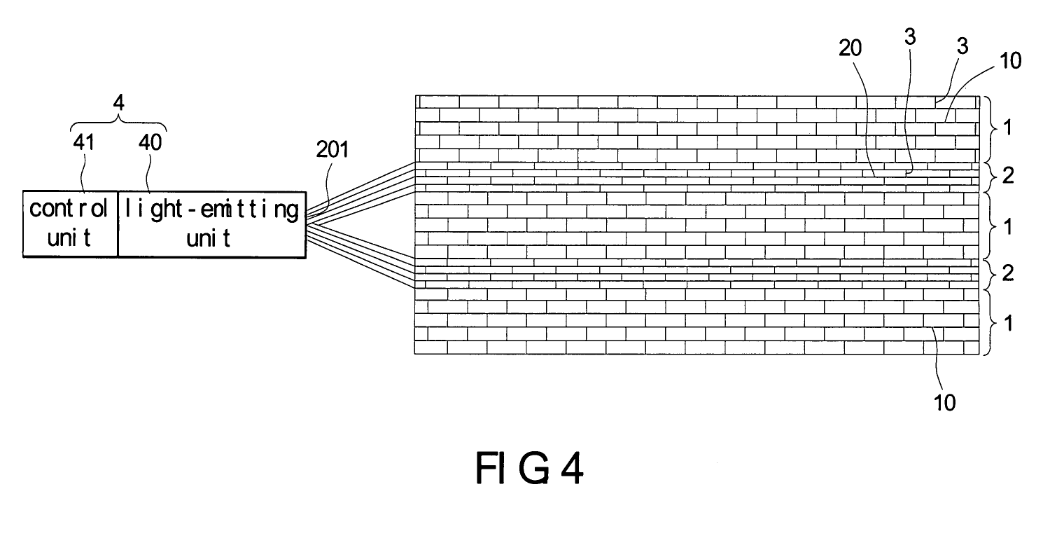

Referring to FIGS. 4 and 5, the third embodiment of the present invention provides a webbing structure with a banded light-emitting effect, comprising: a plurality of opaque band sets 1, a plurality of transparent band sets 2, a plurality of longitudinal opaque wires 3, and a light-emitting module 4.

Moreover, each opaque band set 1 is composed of a plurality of latitudinal opaque wires 10. Each transparent band set 2 is arranged between each two corresponding opaque band sets 1, and each transparent band set 2 is composed of latitudinal flexible transparent wires 20. The longitudinal opaque wires 3 are respectively longitudinally alternately interweaved among the latitudinal opaque wires 10 and the latitudinal flexible transparent wires 20.

Furthermore, the light-emitting module 4 is disposed beside end sides of the transparent band sets 2. The light-emitting module 4 is composed of a light-emitting unit 40 for generating light source and a control unit 41 for controlling the light-emitting unit 40. Hence, when the end sides of the latitudinal flexible transparent wires 20 are bound as the end sides of the transparent band sets 2 to form a light source inlet 201, light source of the light-emitting unit 40 is projected toward the light source inlet 201. Thereby, when the light source is projected from the light-emitting module 4 into the transparent band sets 2, each transparent band set 2 becomes a double-faced banded shining area for lighting as the arrows shown in FIG. 5.

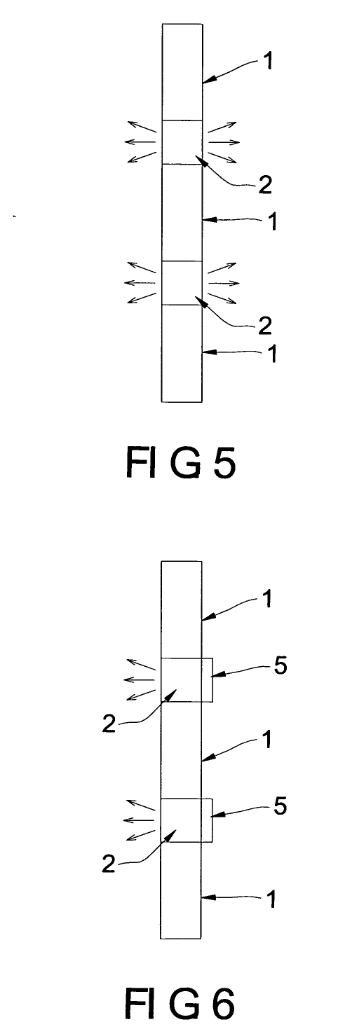

Referring to FIG. 6, the difference between the fourth embodiment and the third embodiment is that the webbing structure of the fourth embodiment further comprises a plurality of reflective layers. Each reflective layer 5 is disposed on one side face of the corresponding transparent band set 2 for only other side face of the corresponding transparent band set 2 generating a corresponding single-faced banded shining area that projects light as the arrows in FIG. 6.

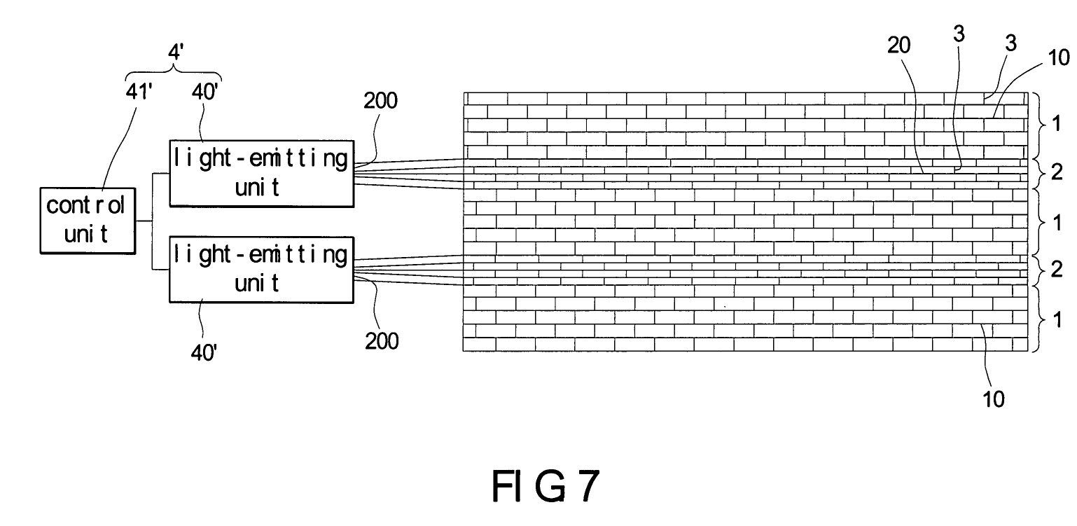

Referring to FIG. 7, the difference between the fifth embodiment and the third embodiment is that the webbing structure of the fifth embodiment provides a light-emitting module 4′ that is composed of a plurality of light-emitting units 40′ for generating light source and a control unit 41′ for controlling the light-emitting units 40′. Hence, when the end side of each transparent band sets 2 is bound to form the light source inlet 200, the light source of each light-emitting unit 40′ is projected toward the corresponding light source inlet 200.

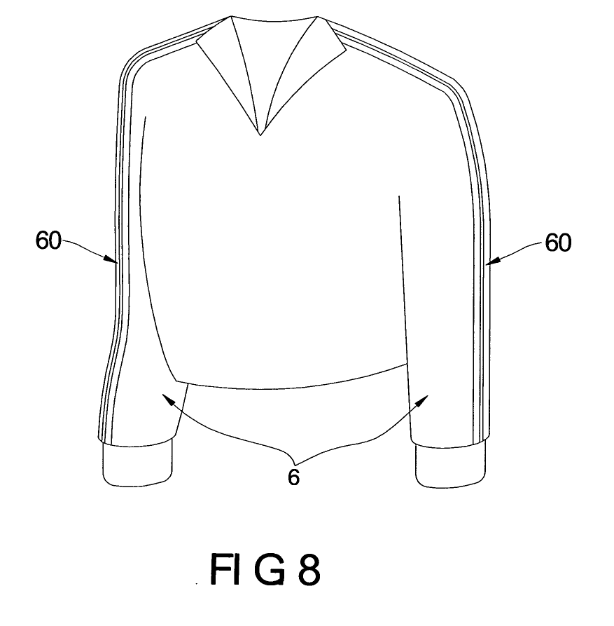

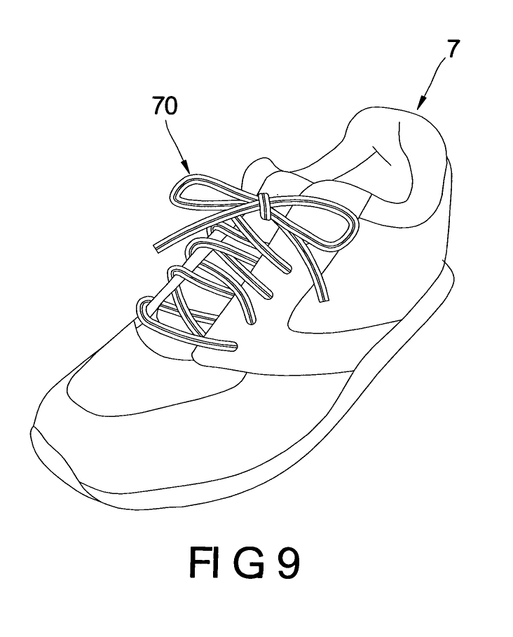

Referring to FIGS. 8 and 9, according to the first embodiment of the present invention, the webbing structure is a decorative band 60 that is applied to two sides 6 of clothing and the webbing structure is a shoelace 70 that is applied to a shoe 7.

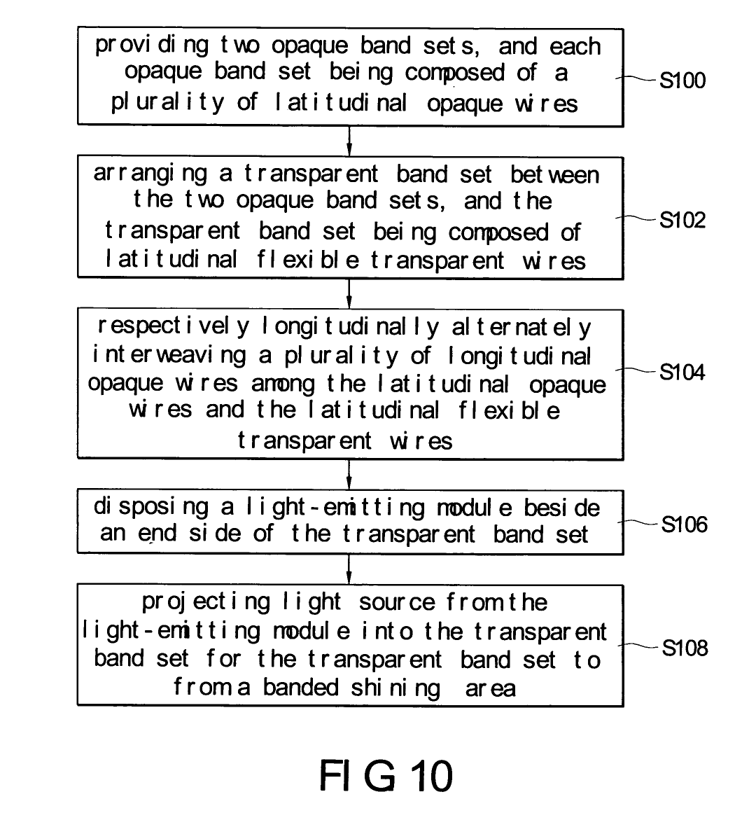

Referring to FIG. 10, the first embodiment of the present invention provides a method for manufacturing a webbing structure with a banded light-emitting effect, comprising: providing two opaque band sets, and each opaque band set being composed of a plurality of latitudinal opaque wires (S100); and then arranging a transparent band set between the two opaque band sets, and the transparent band set being composed of latitudinal flexible transparent wires (S102).

Moreover, the method further comprises: respectively longitudinally alternately interweaving a plurality of longitudinal opaque wires among the latitudinal opaque wires and the latitudinal flexible transparent wires (S104); disposing a light-emitting module beside an end side of the transparent band set (S106); and then projecting light source from the light-emitting module into the transparent band set for the transparent band set to from a banded shining area (S108).

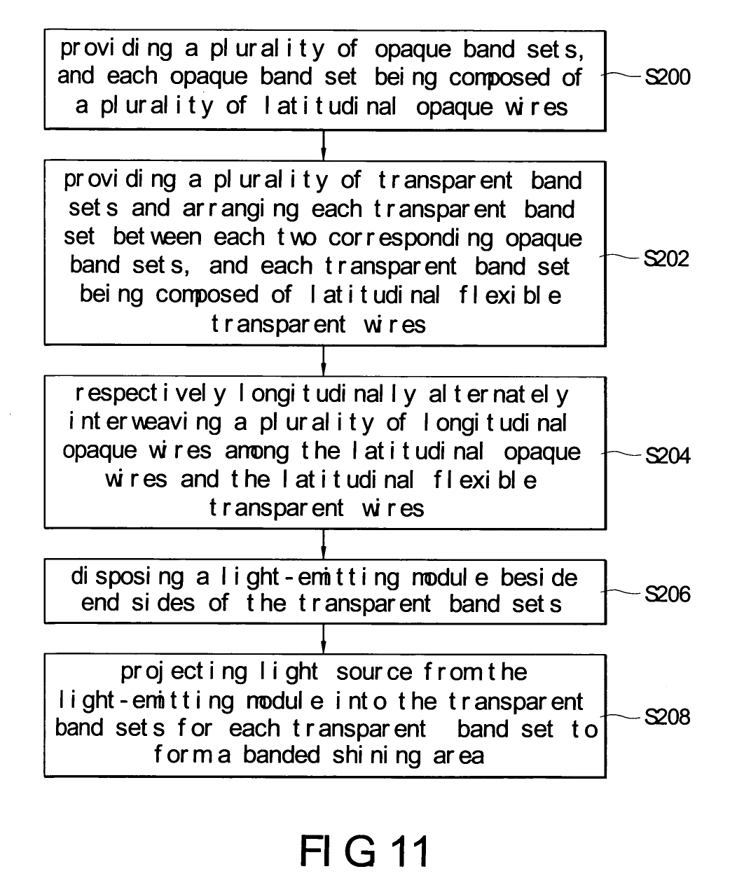

Referring to FIG. 11, the third and the fourth embodiment of the present invention provide a method for manufacturing a webbing structure with a banded light-emitting effect, comprising: providing a plurality of opaque band sets, and each opaque band set being composed of a plurality of latitudinal opaque wires (S200); and then providing a plurality of transparent band sets and arranging each transparent band set between each two corresponding opaque band sets, and each transparent band set being composed of latitudinal flexible transparent wires (S202).

Moreover, the method further comprises: respectively longitudinally alternately interweaving a plurality of longitudinal opaque wires among the latitudinal opaque wires and the latitudinal flexible transparent wires (S204); disposing a light-emitting module beside end sides of the transparent band sets (S206); and then projecting light source from the light-emitting module into the transparent band sets for each transparent band set to form a banded shining area (S208).

In conclusion, the webbing structure of the present invention is manufactured via flexible transparent wires 20 (the transparent band set 2) respectively interweaving with opaque wires each other. Moreover, the light-emitting module 4 or 4′ provides a light source and transmits the light source into the flexible transparent wires for generating a banded shining area.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A webbing structure with a banded light-emitting effect, comprising:
two opaque band sets, wherein each opaque band set is composed of a plurality of latitudinal opaque wires;
a transparent band set arranged between the two opaque band sets, wherein the transparent band set is composed of latitudinal flexible transparent wires;
a plurality of longitudinal opaque wires respectively longitudinally alternately interweaved among the latitudinal opaque wires and the latitudinal flexible transparent wires; and
a light-emitting module disposed beside an end side of the transparent band set;
whereby, when light source is projected from the light-emitting module into the transparent band set, the transparent band set becomes a banded shining area.

2. The webbing structure as claimed in claim 1, wherein the opaque wires are chemical yarns.

3. The webbing structure as claimed in claim 1, wherein the latitudinal flexible transparent wires are made of transparent thermoplastic material.

4. The webbing structure as claimed in claim 1, wherein each flexible transparent wire is selected from the group consisting of polycarbonate, polystyene, polymethyl methacrylate, MMA-styrene Copolymer, thermoplastic Polyurethane and ethylene vinyl acetate.

5. The webbing structure as claimed in claim 1, wherein the light-emitting module is composed of a light-emitting unit for generating the light source and a control unit for controlling the light-emitting unit.

6. The webbing structure as claimed in claim 1, further comprising a reflective layer disposed on one side face of the transparent band set for only other side face of the transparent band set generating the banded shining area.

7. A webbing structure with a banded light-emitting effect, comprising:
a plurality of opaque band sets, wherein each opaque band set is composed of a plurality of latitudinal opaque wires;
a plurality of transparent band sets, and each transparent band set arranged between each two corresponding opaque band sets, wherein each transparent band set is composed of latitudinal flexible transparent wires;
a plurality of longitudinal opaque wires respectively longitudinally alternately interweaved among the latitudinal opaque wires and the latitudinal flexible transparent wires; and
a light-emitting module disposed beside end sides of the transparent band sets;
whereby, when light source is projected from the light-emitting module into the transparent band sets, each transparent band set becomes a banded shining area.

8. The webbing structure as claimed in claim 7, wherein the opaque wires are chemical yarns.

9. The webbing structure as claimed in claim 7, wherein the latitudinal flexible transparent wires are made of transparent thermoplastic material.

10. The webbing structure as claimed in claim 7, wherein each flexible transparent wire is selected from the group consisting of polycarbonate, polystyene, polymethyl methacrylate, MMA-styrene Copolymer, thermoplastic Polyurethane and ethylene vinyl acetate.

11. The webbing structure as claimed in claim 7, wherein the light-emitting module is composed of a light-emitting unit for generating the light source and a control unit for controlling the light-emitting unit.

12. The webbing structure as claimed in claim 7, wherein the light-emitting module is composed of a plurality of light-emitting units for generating the light source and a control unit for controlling the light-emitting units.

13. The webbing structure as claimed in claim 7, further comprising a plurality of reflective layers, wherein each reflective layer is disposed on one side face of the corresponding transparent band set for only other side face of the corresponding transparent band set generating the corresponding banded shining area.

14. A method for manufacturing a webbing structure with a banded light-emitting effect, comprising:
providing two opaque band sets, wherein each opaque band set is composed of a plurality of latitudinal opaque wires;
arranging a transparent band set between the two opaque band sets, wherein the transparent band set is composed of latitudinal flexible transparent wires;
respectively longitudinally alternately interweaving a plurality of longitudinal opaque wires among the latitudinal opaque wires and the latitudinal flexible transparent wires;
disposing a light-emitting module beside an end side of the transparent band set; and
projecting light source from the light-emitting module into the transparent band set for the transparent band set to from a banded shining area.

15. The method as claimed in claim 14, wherein the opaque wires are chemical yarns.

16. The method as claimed in claim 14, wherein the latitudinal flexible transparent wires are made of transparent thermoplastic material.

17. The method as claimed in claim 14, wherein each flexible transparent wire is selected from the group consisting of polycarbonate, polystyene, polymethyl methacrylate, MMA-styrene Copolymer, thermoplastic Polyurethane and ethylene vinyl acetate.

18. The method as claimed in claim 14, wherein the light-emitting module is composed of a light-emitting unit for generating the light source and a control unit for controlling the light-emitting unit.

19. The method as claimed in claim 14, further comprising a reflective layer disposed on one side face of the transparent band set for only other side face of the transparent band set generating the banded shining area.

20. A method for manufacturing a webbing structure with a banded light-emitting effect, comprising:
providing a plurality of opaque band sets, wherein each opaque band set is composed of a plurality of latitudinal opaque wires;
providing a plurality of transparent band sets, and arranging each transparent band set between each two corresponding opaque band sets, wherein each transparent band set is composed of latitudinal flexible transparent wires;
respectively longitudinally alternately interweaving a plurality of longitudinal opaque wires among the latitudinal opaque wires and the latitudinal flexible transparent wires;
disposing a light-emitting module beside end sides of the transparent band sets; and
projecting light source from the light-emitting module into the transparent band sets for each transparent band set to form a banded shining area.

21. The method as claimed in claim 20, wherein the opaque wires are chemical yarns.

22. The method as claimed in claim 20, wherein the latitudinal flexible transparent wires are made of transparent thermoplastic material.

23. The method as claimed in claim 20, wherein each flexible transparent wire is selected from the group consisting of polycarbonate, polystyene, polymethyl methacrylate, MMA-styrene Copolymer, thermoplastic Polyurethane and ethylene vinyl acetate.

24. The method as claimed in claim 20, wherein the light-emitting module is composed of a light-emitting unit for generating the light source and a control unit for controlling the light-emitting unit.

25. The method as claimed in claim 20, wherein the light-emitting module is composed of a plurality of light-emitting units for generating the light source and a control unit for controlling the light-emitting units.

26. The method as claimed in claim 20, further comprising a plurality of reflective layers, wherein each reflective layer is disposed on one side face of the corresponding transparent band set for only other side face of the corresponding transparent band set generating the corresponding banded shining area.
